(19) United States
(12) Patent Application Publication
(10) Pub. No.: US 2017/0039889 A1
(43) Pub. Date: Feb. 9, 2017

(54) Method to teach and learn Chinese

(71) Applicant: YUN WANG, HANGZHOU (CN)

(72) Inventor: YUN WANG, HANGZHOU (CN)

(21) Appl. No.: 15/230,480

(22) Filed: Aug. 7, 2016

Related U.S. Application Data
(60) Provisional application No. 62/202,701, filed on Aug. 7, 2015.

(51) Int. Cl. G09B 19/08

(52) U.S. Cl. CPC G09B 19/08

(57) ABSTRACT

The present invention describes a method to learn Chinese Pinyin using six tables with sequential order. Each table comprises a horizontal reference panel extending from left to right and a vertical reference panel extending from top to bottom. Each table contains Initials and Finals and is represented by one of the Six Single Finals—a, o, e, i, u and ü. The vertical reference panel in each table maintain the same order of 23 initials. Optionally, the Chinese pronunciation corresponding to English pronunciation placed ahead of each Initials in the vertical reference panel.

### CROSS REFERENCE TO RELATED APPLICATIONS

This application take priority from a U.S. provisional application 62/202,701 filed Aug. 7, 2015. The provisional application is incorporated herein by reference in their entireties.

### TECHNICAL FIELD

The present invention relates to a method to teach and/or learn Chinese, in particular, it is related to a method to teach and/learn Chinese Pinyin including both Initials and Finals.

### BACKGROUND OF THE INVENTION

Learning to read and write Chinese is not easy for someone who wants to acquire Chinese as a second language because Chinese characters are not phonetic language. To learn to read Chinese, Pinyin is needed. And Pinyin is one of prominent methods to input Chinese characters into computers and smart phones today. Therefore it is important to master Pinyin.

Pinyin, or Hanyu Pinyin, is the official phonetic system for transcribing the Mandarin pronunciations of Chinese characters into the Latin alphabet in China, Taiwan and Singapore. It is often used to teach Standard Chinese and a Pinyin without diacritic markers is often used in foreign publications to spell/translate Chinese names to non-Chinese.

Chinese Pinyin are generally given in terms of Initials and Finals, which represent the segmental phonemic portion of the language, rather than letter by letter as in English. Initials are initial consonants, while Finals are all possible combinations of medials.

Traditionally, students learn Chinese Pinyin by mechanical repetition reciting new letters or combinations over and over again. This method may be useful for students who acquire Chinese as a first language. As for students who start to learn Chinese as a second language, it is a lot more difficult because the English spelling and phonic rules have already imprinted in their minds. Giving the appeared similarity between Pinyin and American phonetics, many students tend to mix the Pinyin with English Alphabet without an effective solution. Some educational organization has developed educational materials more vivid through advanced technologies, for example making letters more attractive, or use funny content to stimulate students' brain to help memory, but this method is not repeatedly useful for every student on all occasions. Such method neglects the fundamental and underlying connection within Finals, which are part of the foundation of the language itself.

To date, students are still taught to memorize each Pinyin in a brutal force manner. A more innovative and effective teaching and learning method is needed to help English-speaking students to master Pinyin.

### SUMMARY OF THE INVENTION

The present invention is directed to a novel method to help English-speaking students to learn and master Chinese Pinyin in a very short amount of time.

It is one object of the present invention to provide an education material that a student can fell in love with the study material on a first sight as a native English speaker, and the study material can become a friend or companion for a certain amount of time. The method disclosed in the present invention allows a student to relate Chinese Pinyin to English Alphabet closely, so that a student can not only feel Chinese Pinyin friendly and familiar, but also by resonating and leveraging the language rules and building blocks in English, Chinese can be built a lot faster.

It is another object of the present invention to present Chinese Pinyin in a logical or rational way so that beginners can logically and systematically approach the language learning process. Chinese Pinyin can appear very unorganized and chaotic for a native English speaker at the beginning, especially under the old method how Chinese is taught as a first language. The new method provided herein arranges all Pinyin in a very systematic manner. The method disclosed herein displayed the language in a pictorial and systematic manner, so that a learner can easily remember.

It is still another object of the present invention to summarize Chinese Pinyin in tables, which can be used as a “cheat sheet,” as a concise set of notes used for quick/handy reference. The tables developed in the present invention help memorization in a more intellectual manner. The tables have similarities as well as distinctions. The similarities between different tables would help learner reinforce the use and the role of Initials through repetition whereas the distinctions will help the user to engage different vowels or single Finals and their associated compound Finals, and master the entire Pinyin in a divide-and-conquer manner.

In accordance with the teachings of the present invention as disclosed herein, there is provided an education method for Pinyin. The method arranges all Pinyin in six separate tables. Each table has a horizontal axis, or first header row, which is directed to only one representative single Final. The six tables are arranged in a sequential order of a, o, e, i, u, and ü. The six tables are arranged in Chinese alphabetical order according to tone marking principle. Each tables is comprised of one horizontal and one vertical reference panel. By choosing specific Initial and Final on each axis, Pinyins are created at the cross-points where the row and column meets, a cell. In each six tables, all Pinyin that can be associated with, are displayed at one glance.

Further, the horizontal reference panel of each table begins with one of the six single Finals (vowels)—“a, o, e, i, u, ü” followed by its own derivatives. The derivatives, Compound Finals, are also arranged in particular alphabetical order beginning from simple to complex, left to right.

Further, for each table the vertical reference panel is composed of 23 Initials arranged in English alphabetical order from top to down. The 23 Initials are b, c/ch, d, f, g, h, j, k, l, m, n, p, q, r, s/sh, t, w, x, y, and z/zh.

All the Pinyins are therefore summarized in six tables in a very succinct manner. By scanning these tables, learners can quickly know how Chinese words are created through combining Initials and Finals together, and master the language in a very short amount of time is not a mission impossible any more.

### BRIEF DESCRIPTION OF THE DRAWINGS

The invention will be readily understood by the following detailed description in conjunction with the accompanying drawings, wherein like reference numerals designate like structural elements, and in which:

FIG. 1 is an illustration an exemplary first table in accordance with the present invention;

FIG. 2 is an illustration an exemplary second table in accordance with the present invention;

FIG. 3 is an illustration an exemplary third table in accordance with the present invention;

FIG. 4 is an illustration an exemplary fourth table in accordance with the present invention;

FIG. 5 is an illustration an exemplary fifth table in accordance with the present invention;

FIG. 6 is an illustration an exemplary sixth table in accordance with the present invention;

FIG. 7 is an illustration an exemplary single combined table in accordance with the present invention, wherein the Initials are arranged in alphabetic order; and

FIG. 8 is an illustration an exemplary single combined table in accordance with the present invention, wherein the Initials are arranged in phonetic order.

### DETAILED DESCRIPTION OF EXAMPLE EMBODIMENTS

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents that can be included within the spirit and scope of the described embodiments as defined by the appended claims.

Chinese Hanyu Pinyin or Pinyin, is made of Initials and Finals. The Initials include b, p, m, f, d, t, n, l, g, k, h, j, q, x, zh, ch, sh, r, z, c, and s. Finals include “a, o, e, i, u, ü” and “ai, an, ao, ang, ou, ong, ei, en, er, eng, ia, ie, in, iu, iao, ian, iang, ing, iong, ua, ui, un, uo, uai, uan, uang, üe, üu, üan”. In many cases, a person who has had English as a first language naturally hard to relate these Initials and Finals with native alphabets, drawing upon what has been useful in the building blocks in the English language to serve its new purpose in learning Chinese as a second language.

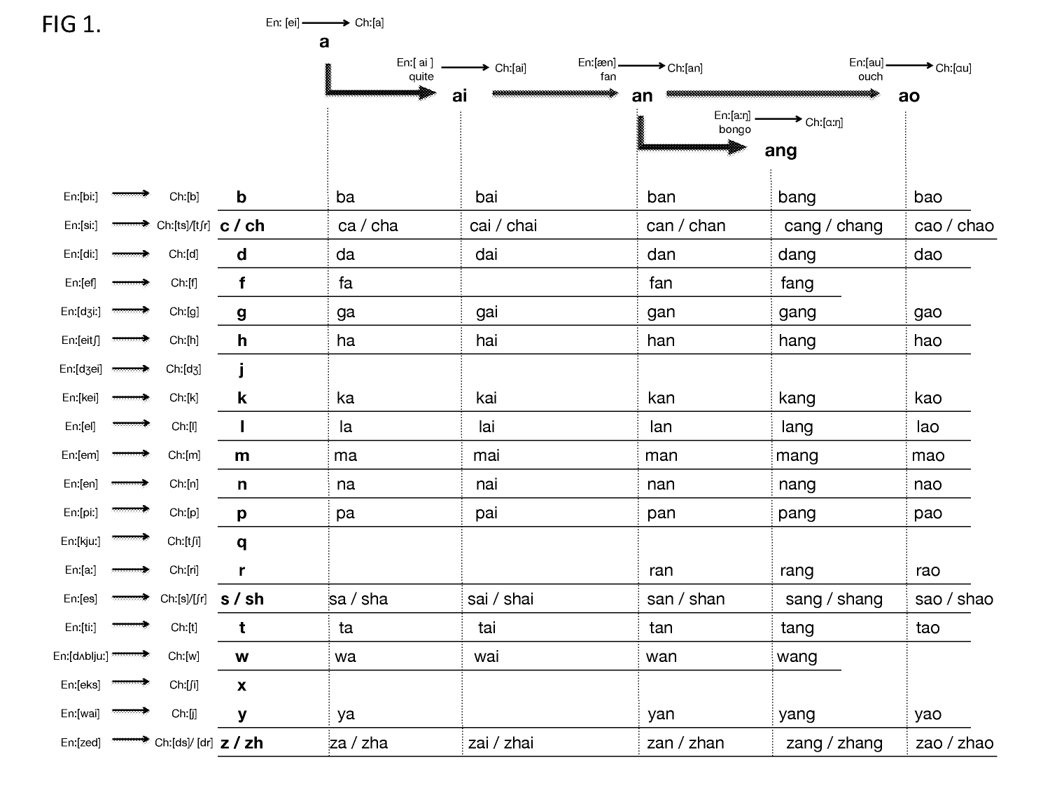

The present invention describes a faster learning method for Chinese Pinyin. The method includes using six tables. Exemplary tables from 1-6 are illustrated in FIGS. 1-6. As shown, each table comprises rows and columns. Each table is directed to one of the single Finals, wherein the single Finals are a, e, i, o, u and ü. Each tables comprises a horizontal reference panel and vertical reference panel, with Pinyin combined inside. The horizontal reference panel is placed on the top of each table and the vertical reference panel is placed on the left side of the table or the most left column of the table.

In one aspect of the present invention, each table comprises a horizontal reference panel, comprising a single Final and its corresponding derivatives.

The horizontal reference panel placed on the top of each table is directed only to one of the single Finals, selected from a, e, i, o, u and ü, and their corresponding derivatives. The 6 single Finals are also referred as vowels.

Referring to FIG. 1, in a first table, which is directed to single Final “a,” wherein the horizontal reference panel for the first table is directed to “a” and its derivatives. That is “a” is placed at the most left position as level 1, and followed by its own derivatives, “ai, an, and ao”, as level 2. Further under “an”, the three letter compound Final “ang” is followed as level 3.

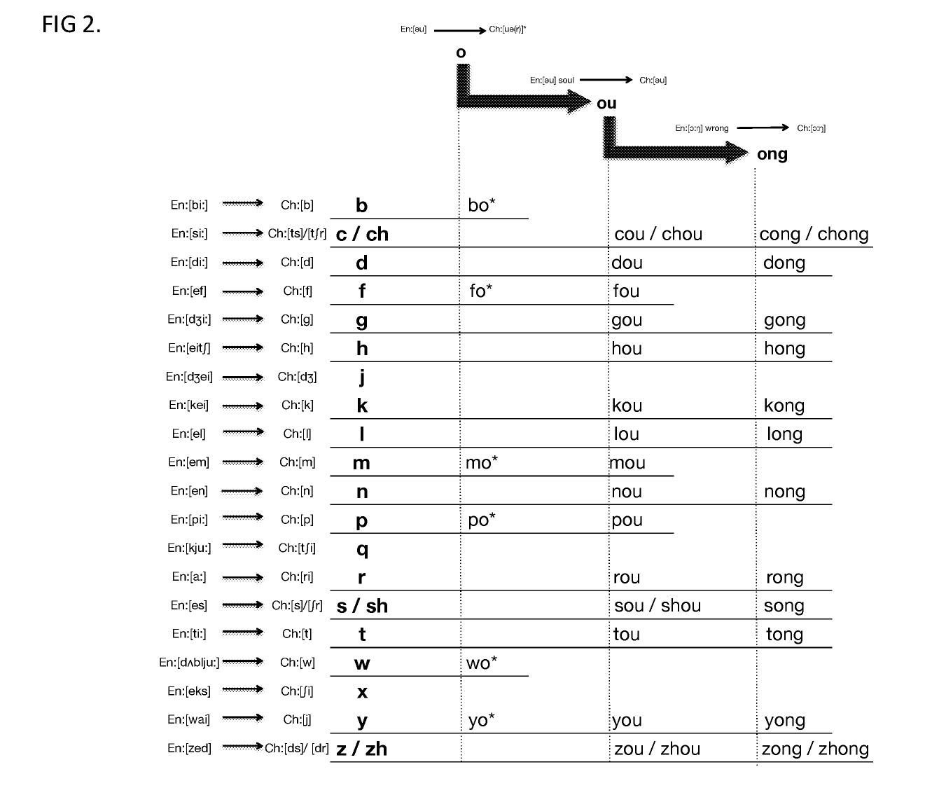

Referring to FIG. 2, in a second table, which is directed to single Final “o,” wherein the horizontal reference panel for the first table is directed to “o” and its derivatives. That is, “o” is placed at the most left position as level 1, and followed by its own derivatives, “ou,” and “ong”, as level 2.

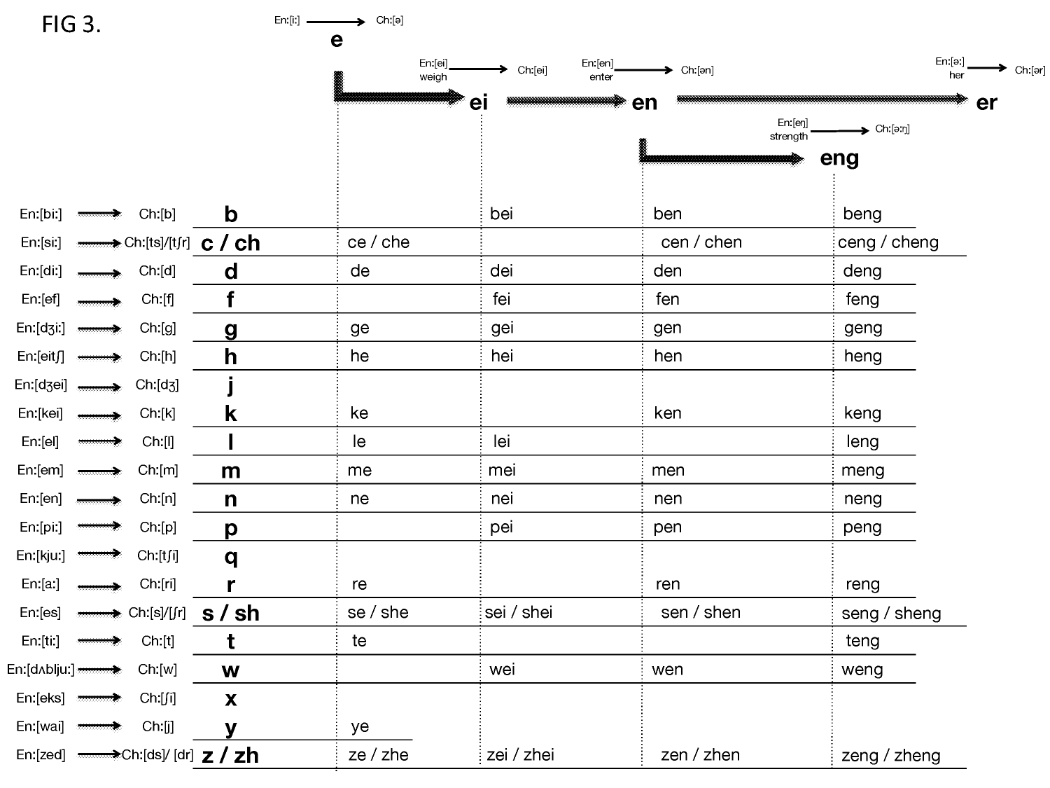

Referring to FIG. 3, in a third table, which is directed to single Final “e,” wherein the horizontal reference panel for the first table is directed to “e” and its derivatives. That is, “e” is placed at the most left position as level 1, and followed by its own derivatives, “ei,” “en,” and “er”, as level 2. Further under “en”, the “eng” is followed as level 3.

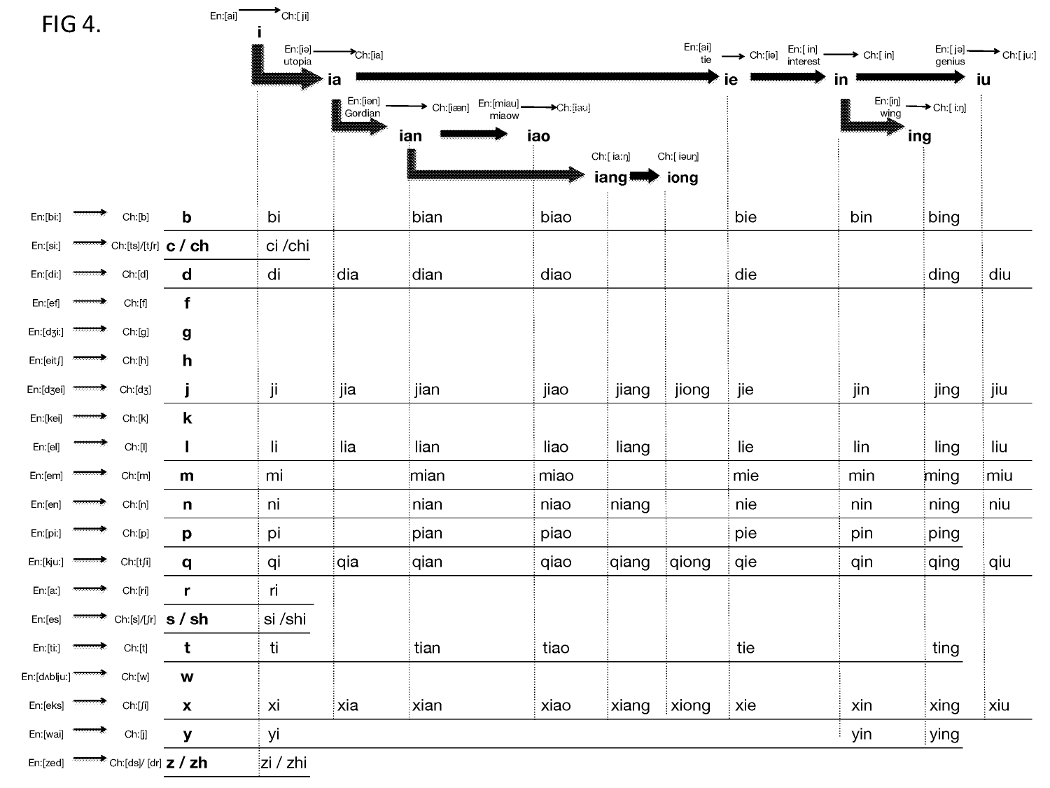

Referring to FIG. 4, in a fourth table, which is directed to single Final “i,” wherein the horizontal reference panel for the first table is directed to “i” and its derivatives. That is, “i” is placed at the most left position as level 1, and followed by its own derivatives, “ia,” “ie,” “in,” and “iu”, as level 2.

Further, at a secondary derivative level, under “ia”, the “iao” and “ian” are followed, and under “in”, the “ing” is followed as level 3. Then, under “ian”, the tertiary derivative “iang” and “long” are placed as level 4.

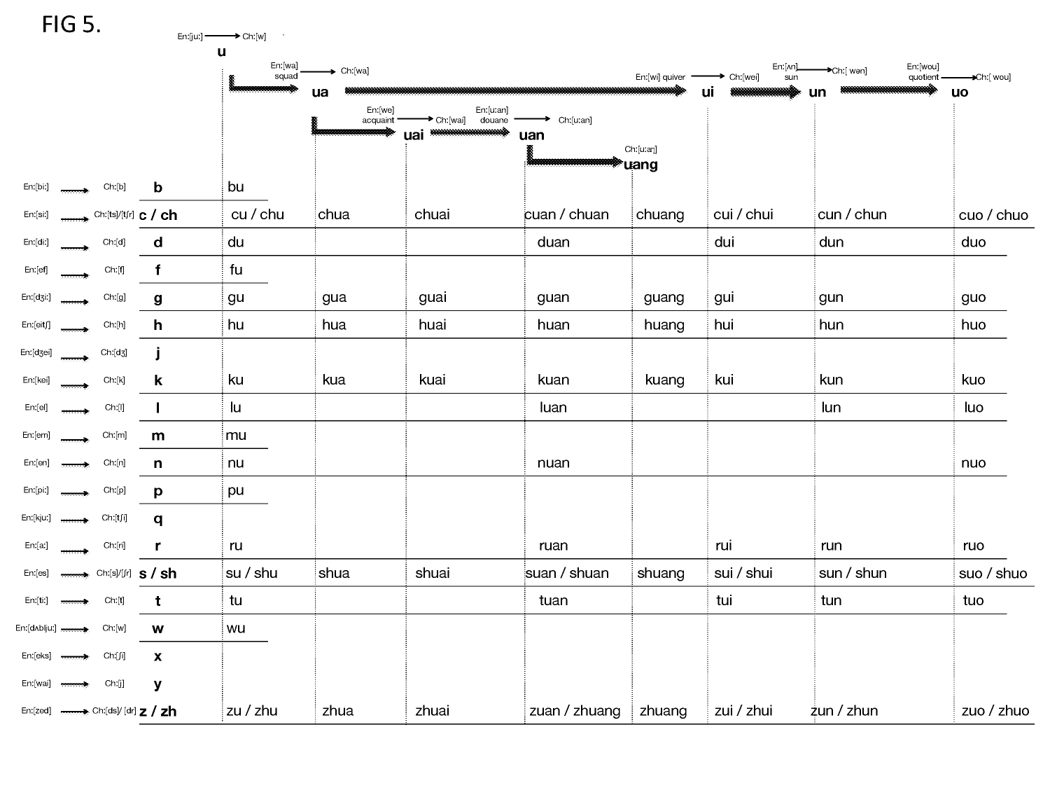

Referring to FIG. 5, in a fifth table, which is directed to single Final “u,” wherein the horizontal reference panel for the first table is directed to “u” and its derivatives. That is, “u” is placed at the most left position as level 1, and followed by its own derivatives, “ua,” “ui,” “un,” and “uo”, as level 2. Further, under “ua”, the secondary derivatives “uai” and “uan” are followed as level 3. And, under “uan”, the tertiary derivative “uang” is followed as level 4.

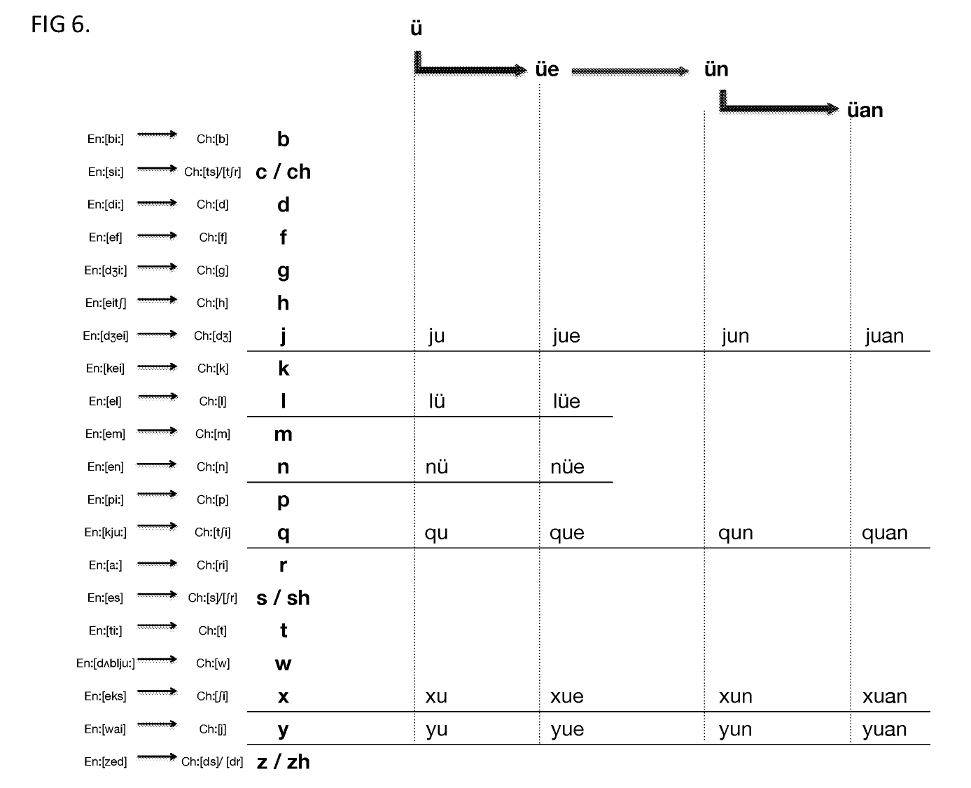

Referring to FIG. 6, in a sixth table, which is directed to single Final “ü,” wherein the horizontal reference panel for the first table is directed to “ü” and its derivatives. That is, “ü” is placed at the most left position as level 1, and followed by its own derivatives, “üe,” and “ün” as level 2. Further, under “ün”, the secondary derivative “üan” is followed as level 3.

The compound Finals, in the present invention are referred as derivatives with their corresponding single Finals, because the compound Finals are formed by attaching any one of the other 8 letters—“a, e, i, o, u, r, n, g” to the six single Finals, “a, e, i, o, u, r, n, g”. Linking all compound Finals as derivatives of single Finals logically connects all Finals effectively, which makes the learners easy to reference to each other and recall them throughout the learning process.

The compound Finals, referred as derivatives of their corresponding single Finals, are arranged from simple to complex, in the horizontal reference panel in each table. In each table, secondary derivatives immediately following the single Final, then the tertiary derivative follows the secondary derivative. When there is more than one derivative at the same level, among either secondary derivatives or tertiary derivatives, the derivatives are arranged in accordance with English alphabetical order from left to right.

In a second aspect of the present invention, each table comprises a vertical reference panel, comprising a total of 23 initials, including b, c/ch, d, f, g, h, j, k, l, m, n, p, q, r, s/sh, t, w, x, y, and z/zh.

In one example, the vertical reference panel is composed of 23 Initials arranged in English alphabetical order from top to bottom. For a native English speaker, it can easily found that six alphabets—“a,” “e,” “i”, “o,” “u,” and “v” are absent from the 26 English alphabet. Instead, three Chinese Initials “ch”, “sh”, and “zh” are added.

In another example, in the vertical reference panel of each table, “c” & “ch”, “s” & “sh”, “z” & “zh” are placed next to each other shoulder by shoulder, which is intentionally designed to assist comparison and help memorization. Or comparative memorization process.

In a third aspect of the present invention, each table comprises a horizontal and vertical reference panels. Combining a letter from the vertical reference panel with a letter from the horizontal reference panel, a Pinyin is formed. From the tables a learner can confidentially decide what combination can make into a Pinyin and what combinations are forbidden and cannot be made into a Pinyin.

In a fourth aspect of the present invention, each table further provides Chinese pronunciation of Initials and Finals, which are displayed as “Ch: [ ]” with phonetic sign attached. Further, the Chinese pronunciation of Initials and Finals, displayed as “Ch: [ ]” is accompanied by the closest pronunciation from English, which is labeled as “En: [ ].” Practically, every time, a user try to use the table to create a Pinyin or look up a Pinyin from the table, the attached pronunciation will make a user more attempted to sound the word out, through repetition, a user will strength the pronunciation naturally without much devoted labor.

In one embodiment of the present invention, the method to teach and learn Chinese Pinyin leverages the most of English alphabets. In one example, the tables are arranged in English alphabetic order, from b, c/ch, d, f, g, h, j, k, l, m, n, p, q, r, s/sh, t, w, x, y, and z/zh sequentially. In one example as a booklet, the table directed to “a” comes as page 1; the table directed to “o” comes as page 2, the table directed to “e” comes as page 3, the table directed to “i” comes as page 4, the table directed to “u” comes as page 5; and the table directed to “0” comes as page 6. In another example, the education material comes in as a pamphlet, the tables are arranged like in a calendar style, the tables directed to “a, e, i,” comes before the tables directed to “o, u, ü.”

In another embodiment of the present invention, the method uses logic mapping for each Pinyin word. First, each compound Finals is dissected to smaller building blocks. Second, each Pinyin word has an individual address in the table depending on its origins (single final and Initial) and its relationship with the single Final. This method not only helps a student to memorize but also helps a person to look up for a Pinyin. Furthermore, through these condensed tables, all common used Pinyin can be found quickly at a glance.

Referring FIGS. 1-6, each table is arranged centered around one Finals selected from a, e, l, o, u, and ü. Each table comprises a horizontal reference panel of the selected Final and a vertical reference panel of all the Initials.

The horizontal reference panel can be placed anywhere a row is placed. In one example, the horizontal reference panel is a header, positioned on/as the first row at the top. In another example, horizontal reference panel is a footer, positioned as the last row at the bottom. In still another example, the horizontal reference panel can be in the middle of the table. Optionally, the horizontal reference panel of the Finals can be a frozen panel, which means the horizontal reference panel of the Finals does not move vertically when other rows of the same table move up or down like a frozen row in a excel.

The horizontal reference panel comprises three or four progressive levels of the Final. The progressive levels of the Final are arranged in increasing levels in vertical order from top. For compound Finals in the same progressive level, different compound Finals are arranged horizontally, from left to right. The compound Finals are positioned in different progressive levels are placed in different rows, preferably, with an angled arrow to suggest the logic direction of how the binary, tertiary and quaternary compound Finals are derived.

The position of horizontal reference panel can be either on the most top or most bottom to at different learning stage to achieve different learning purposes. For example, in order to learn how to combine an Initial and Final to form a Pinyin, the horizontal reference panel of initials is placed on the top, as most of the people read from top to bottom. In another example, in order to learn how to decompose a Pinyin into Initial and Final components, the horizontal reference panel of initials is placed on the bottom.

The vertical reference panel of all the Initials can be placed anywhere a column is. In one example, the vertical reference panel is placed on the most left. In another example, the vertical reference panel is positioned on the most right. In still another example, the vertical reference panel can be placed in the middle of the table. Optionally, the vertical reference panel of the Initials can be a frozen panel, which means the vertical reference panel of the Initials does not move horizontally when other rows of the same table moves to the left or right like a frozen column in a excel.

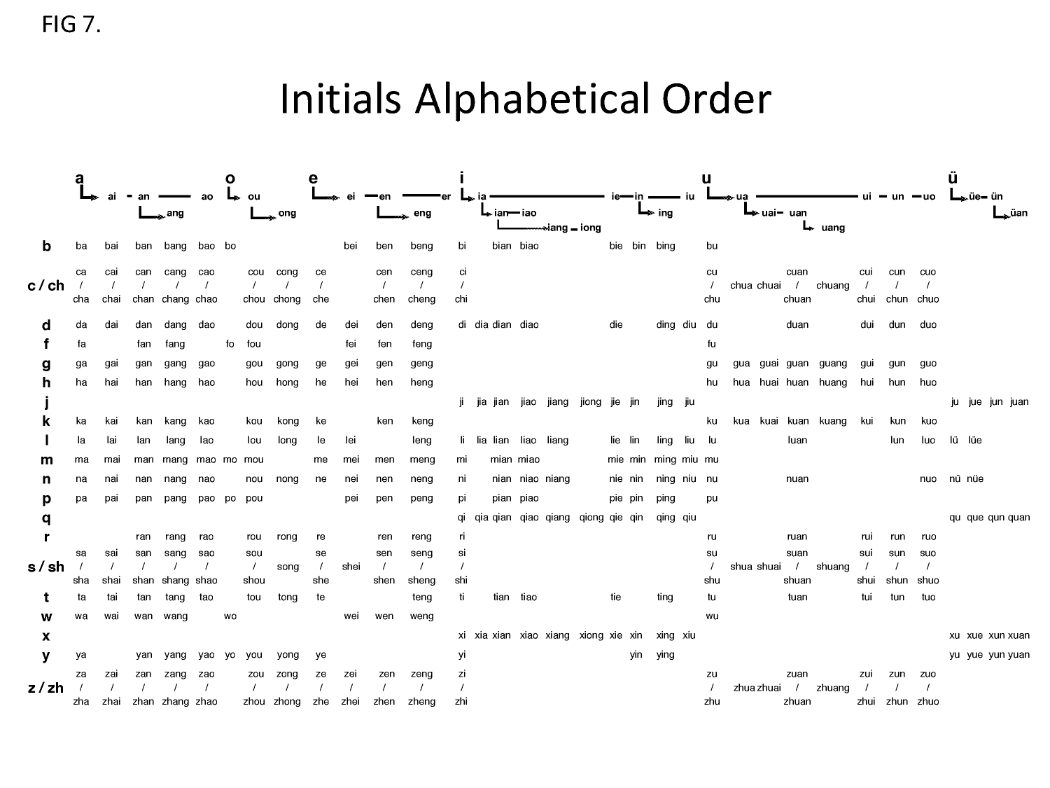

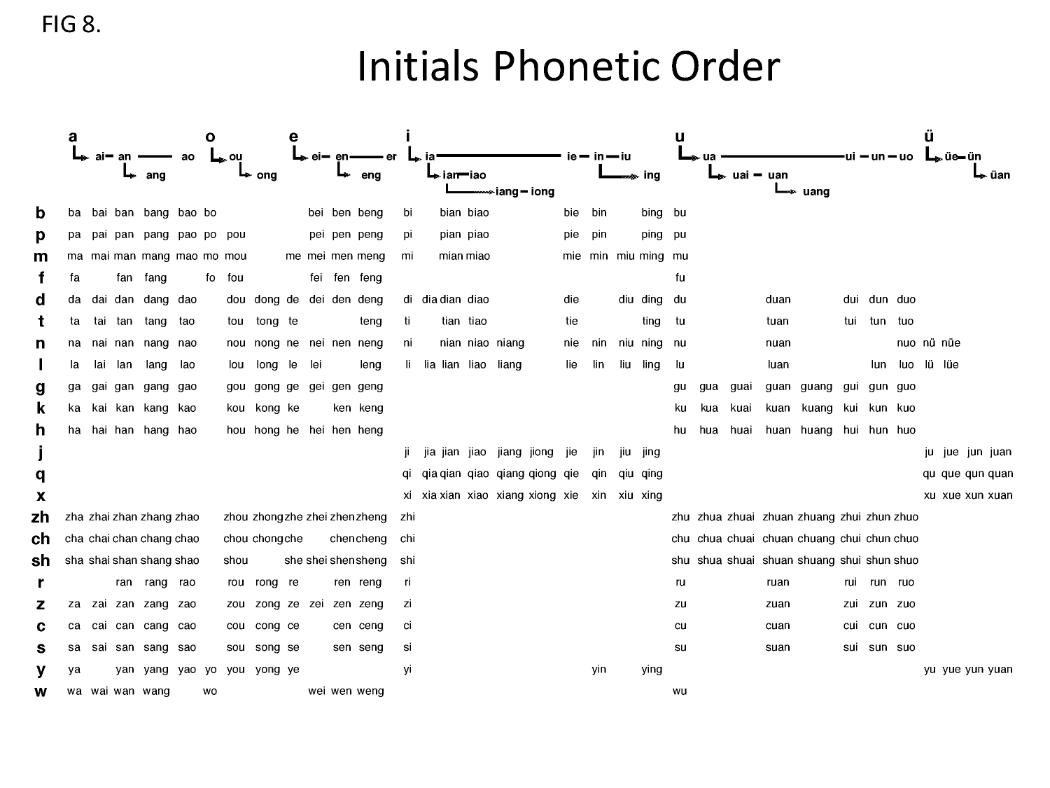

The vertical reference panel is consisting of all the Initials. The Initials are a total of 23, wherein three initials combined with its closest other Initial to share one line or row, as a result there are a total of 20 rows of the table. The Initials c and ch share one row. The Initials s and sh share one row. The Initials z and zh share one row. Each Initial take one row space in the table. Each shared-row initials takes also take one row in the table, but can be arranged in either linearly or non linearly to assist viewing The total of 20 Initials or shared show initials are arranged vertically from top to bottom in a logical order. The vertical logical order includes Alphabetical order and Phonetic order. For example, in FIG. 7, the initials are arranged in Alphabetical order. In FIG. 8, the initials are arranged in Phonetic order.

The position of vertical reference panel can be either on the most left or most right to at different learning stage to achieve different learning purposes. For example, in order to learn how to combine an Initial and Final to form a Pinyin, the vertical reference panel of initials is placed on the left, as most of the people read from left to right. In another example, in order to learn how to decompose a Pinyin into Initial and Final components, the vertical reference panel of initials is placed on the right.

Optionally, in FIGS. 1-6, the Chinese and English pronunciations of the Initials can be also listed side-by-side comparison and easy memorization purpose.

In the figures, the pinyins are included in tables that are two dimensional. But this does not

The method disclosed herein, offer a very friendly approach to learn Chinese Pinyin. The Pinyin word will become easy to remember by using the tables provided. Even in rare occasions that a Pinyin word is forgotten, because of the building blocks provided in the table, the memory can be reconstructed in logic quickly.

The method described in the present invention, provides a clear logical structure of Pinyin which helps learner to master the Pinyin much more faster than ever before. In real-world teaching trial, it has shown that even middle aged people in US only need to spend a few hours to understand all Pinyin, which usually take younger students several months to memorize the same amount of work in school.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not meant to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages, including portability, adjustability to different heights, lightweight, stability, easy disassembly and assembly, etc. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

I claim:

1. An article to teach or learn Chinese Pinyin comprising:
six tables, assisting to learn Chinese Pinyin, each is directed to an individual single Final and its derivatives, wherein the single Final is selected from the group of a, e, i, o, u and ü;
each table comprises a horizontal reference panel,
and a vertical reference panel,
wherein each single Final and derivatives is arranged in the horizontal reference panel of the table.

2. The article of claim 1, wherein each vertical reference panel comprises Initials of Pinyin.

3. The article of claim 1, wherein the Intials of Pinyin are 23, including b, c, ch, d, f, g, h, j, k, l, m, n, p, q, r, s, sh, t, w, x, y, and z, zh.

4. The article of claim 1, wherein the single Finals and its derivatives are arranged in a progressive manner with leveled structure, including Secondary, ternary, and quaternary derivatives are arranged after their respective Finals.

5. The article of claim 1, wherein the tables in the article are arranged in the order of “a, o, e, i, u, ü” in accordance with a phonetic order.

6. The article of claim 1, wherein within the same level of derivatives, the Finals are arranged in alphabetic order.

7. The article of claim 1, wherein each table further comprises Chinese pronunciations.

8. The article of claim 1, wherein each table further comprises English pronunciations.

9. The article of claim 1, wherein Chinese pronunciation corresponding to the nearest English pronunciation.

10. The article of claim 1, wherein a place where a row and a column meet to build a pinyin.

11. The article of claim 1, wherein tables are arranged in sequential order.

12. The article of claim 1, wherein tables are arranged substantially like a calendar manner.

13. The article of claim 3, wherein the c and ch, s and sh, z and zh are arranged in pairs share one row in the vertical reference panel.

14. An article to teach or learn Chinese Pinyin comprising:
a tabular arrangement of pinyins, each pinyin is placed in a cell according to its Initial and Final;
the article comprises a horizontal reference panel and vertical reference panel;
wherein the horizon al reference panel comprises Finals and the vertical reference panel comprises Initials arranged either in alphabetic or phonetic order.

15. The article of claim 14, wherein the horizontal reference panel of Finals are placed above the cells of the pinyins.

16. The article of claim 14, wherein the horizontal reference panel of Finals are placed above the cells of the pinyins.

17. The article of claim 14, wherein the vertical reference panel of Initials are placed left to the cells of the pinyins.

18. The article of claim 14, wherein the vertical reference panel of Initials are placed right to the cells of the pinyins.
